(19) United States
(12) Patent Application Publication
(10) Pub. No.: US 2014/0248951 A1
(43) Pub. Date: Sep. 4, 2014

(54) SPORTS GAME AND METHOD

(71) Applicants: Ron Kronengold, Jericho, NY (US); Michael Bernstein, Commack, NY (US); Charles Tucker, Huntingdon Valley, PA (US)

(72) Inventors: Ron Kronengold, Jericho, NY (US); Michael Bernstein, Commack, NY (US); Charles Tucker, Huntingdon Valley, PA (US)

(21) Appl. No.: 14/195,968

(22) Filed: Mar. 4, 2014

Related U.S. Application Data
(60) Provisional application No. 61/772,072, filed on Mar. 4, 2013.

(51) Int. Cl. A63F 13/00

(52) U.S. Cl. CPC A63F 13/00
USPC 463/31

(57) ABSTRACT

In a preferred embodiment of the present invention there is provided games and methods which combine the features and benefits of fantasy gaming with survivor pool gaming. A preferred embodiment employs a user fantasy game roster comprising a plurality of real-world players from a professional sports league, selected from various available positions. Players may be selected by a user regardless of whether that same player was selected by another user. After players are successfully selected, a user is awarded points based on game events. Once a user selects a real-world player for a given game period, that player may not be selected again by that user for a restricted period of time, typically the remainder of the season. At the conclusion of each game period, the lowest tier of users is eliminated. The process is repeated until the final game period when a winner is selected.

This application claims priority to U.S. Provisional Application Ser. No. 61/772,072, filed on Mar. 4, 2013 and incorporated herein by reference.

### FIELD OF THE INVENTION

The present invention relates to the field of recreation and gaming. More particularly, the present invention combines features of fantasy sports gaming and survivor pools, whereby fantasy team rosters are managed by users, points are awarded based on real-time player performances and user teams are regularly eliminated, depending on their performances.

### BACKGROUND OF THE INVENTION

Fantasy sports games are well known in the field of gaming. For example, in the context of fantasy football, users manage rosters of real-world NFL players and are awarded points based on player performance. In traditional fantasy games, rosters are assembled via a draft and players remain on the roster unless traded or the season ends. In many fantasy football formats, each player can only be drafted by one user and therefore by design, this limits the number of participants in the game.

A fantasy football roster generally comprises players at various positions and may include any number of players. While many configurations are possible, in one typical format, a roster may comprise 1 quarterback, 2 running backs, 2 wide receivers, 1 tight end, 1 kicker and 1 defense/special teams (along with optional spots for flex, bench and/or reserve players).

In a typical point system, players at the aforementioned selected positions are awarded points for various in-game achievements. One example of a point system provides:

TABLE 1
For Quarterbacks, Running Backs, Wide Receivers and Tight Ends

| Points | Game Event |
|---|---|
| 6 | Rushing or Receiving TD |
| 6 | Returning Kick/Punt for TD |
| 6 | Returning or Recovering a Fumble for TD |
| 4 | Passing TD |
| 2 | Passing, Rushing or Receiving 2-Point Conversion |
| 1 | 10 Yards Rushing or Receiving |
| 1 | 25 Yards Passing |

TABLE 2
For Kickers

| Points | Game Event |
|---|---|
| 5 | 50+ Yard FG |
| 4 | 40-49 Yard FG |
| 3 | 39 (or fewer) Yard FG |
| 2 | Passing, Rushing or Receiving 2-Point Conversion |
| 2 | Rushing or Receiving 2-Point Conversion |
| 2 | Passing 2-Point Conversion |
| 1 | Extra Point |

TABLE 3
For Defenses

| Points | Game Event |
|---|---|
| 10 | 0 points allowed |
| 7 | 2-6 points allowed |
| 5 | 7-13 points allowed |
| 0 | 14+ points allowed |
| 2 | Interception |
| 2 | Fumble Recovery |
| 2 | Safety |
| 2 | Sack |

In addition to the foregoing scoring system that may be utilized, players may be awarded bonus points based upon ‘big plays’ (40+ yard touchdown pass, run or reception). Likewise, points may be deducted from players based on negative performances such as fumbles or interceptions.

As real-world NFL games are played, each fantasy NFL player on a user's roster accumulates points based on their real-world player performances. In NFL fantasy football, at the end of a given week's games, points that are accumulated are carried over into the following week. In formats that have head-to-head matchups, points are typically reset week to week, but may be accumulated and retained for purposes of deciding tie-breakers and/or playoff seeding. In a typical format, at or near the conclusion of the NFL regular season, a winner is crowned (e.g., based on most accumulated points, being the winner of the most head-to-head matchups or being the winner of a fantasy playoff). Fantasy games may also carry over into the NFL playoffs in a similar manner, utilizing players from the real-world NFL teams entering the NFL playoffs.

Survivor pool games are also well known in the field of gaming, and particularly in the context of the NFL. In a typical preferred format, a survivor pool is a contest in which participants select one NFL team each week to win its game without regard to the point spread. If the selected team wins, the participant “survives” and continues to the next week. If the participant's team loses, the participant is eliminated from the pool. To add a component of ‘skill,’ a participant cannot select the same team twice in a given season. Other variations require that a team cannot be selected twice in back-to-back weeks, but to compensate for this leniency, more than one team must be chosen each week. Regardless of the format, the last participant who chooses correctly wins. If more than one participant ‘survives,’ the pot may be divided among the surviving participants.

While fantasy games and survivor pools are individually popular, there has never been a combination of these two games which merges the size, excitement and sudden death nature of a survivor pool with the week-to-week, season-long grind of a fantasy game.

Moreover, in instances of fantasy gaming where one or more ‘strong’ teams with more productive and/or explosive players often rise to the top as the season progresses, it is virtually impossible for a weaker team to be victorious at the end of the season. Even with league waiver wires which award higher selections and better players to weaker teams in the middle of a given fantasy season, the disadvantage is often insurmountable over the course of a season. This aspect of fantasy gaming often leads to neglect of a user's lame-duck team by mid-season and a negative experience for an appreciable percentage of users. Accordingly, there is a need to provide an ‘equalizer’ to fantasy sports gaming which will keep each user interested until that user's actual elimination or victory.

### SUMMARY OF THE INVENTION

In view of the drawbacks of the prior art, it is a primary objective of the present invention to provide a game and method that combines the aspects of fantasy sports gaming and survivor pools into an innovative and exciting gaming experience for users.

It is a further objective of the present invention to provide a game and method that enhances the fantasy sports gaming experience for users and keeps users interested until actual elimination.

It is another objective of the present invention to provide a game and method wherein each roster exists for a limited amount of time (e.g., with regard to football that time would be one week) and multiple users may select the same real-world players on their fantasy roster.

Additional objectives will be apparent from the description of the invention that follows:

In summary, there is provided in a preferred embodiment of the present invention games and methods which combines the features and benefits of fantasy gaming with survivor pool gaming. A preferred embodiment of the present invention employs a user fantasy game roster comprising a total of four real-world players from the National Football League (“NFL”), one of which is selected from each of four offensive positions or categories, namely, quarterback (QB), running back (RB), wide receiver/tight end (WR/TE) and kicker (K). Real-world players may be selected by a user regardless of whether that same real-world player was selected by another user. After players are selected to fill a user fantasy game roster, the user is awarded points based on game events. Once a user selects a real-world player for a given week or game period, that player may not be selected again by that user for a restricted period of time, which may be varied depending on the desired rules and parameters of the league in which the game and method are being utilized.

While a particular game span may be limited to a duration that is as short as a single week or game, it is preferable that the game span extend, for example (a) over an entire regular season, (b) over a playoff period, or (c) over multiple weeks. In the context of NFL football, it is most preferable that the game span extend over 14-17 weeks of the NFL regular season or for the NFL playoffs. When a game span extends over multiple weeks, each game span comprises game periods. When fantasy players are selected from the NFL, each game period corresponds to a week of the NFL regular season or playoffs (i.e., wild card round, divisional round, championship round, Super Bowl).

Once players are successfully selected to a user roster, the selected players earn fantasy football points each week, which are accumulated by a user team. Preferably, points accumulate in real-time based upon in-game events at the NFL games in which the players are playing. Thus, for example, if a RB on a user roster scores a touchdown during the game, that user's team will have accumulated 6 points, and those points would appear on the user interface in real-time (or soon after the play ends, which may also be considered real-time).

As points are tallied, a list or hierarchy of user teams playing in a given game period is formed. The higher scoring teams appear towards to the top, and the lower scoring teams appear near the bottom. After a game period concludes, teams finishing a game period in the lowest tier or elimination tier are eliminated from contention. The process continues and repeats itself for the remaining user teams in a league in the following remaining game periods until one or more winners are selected. In a preferred embodiment, the winner is the user with the highest accumulated point total over the game span, provided that user is still in contention in the final game period and has not previously been eliminated. Alternatively, the winner can be the user with the highest point total in the final week of the season. Likewise, it should be appreciated that multiple winners can be selected based on the highest accumulated or final-week totals.

The games and methods of the present invention are preferably implemented over a network-based system such as the Internet, with users participating by operating CPU-controlled devices (e.g., computers, handheld devices) which are operatively connected in a client-server arrangement to one or more CPU-controlled devices (e.g., servers). The CPU-controlled devices comprise non-transitory storage media on which software comprising program instructions is stored and run. Appropriate hardware, software and databases, which are known to those of ordinary skill in the art, are also employed to maintain, store and process the data in connection with the game and method of the present invention.

By combining traditional fantasy gaming with survivor pool gaming, users can enjoy the best of both worlds through the merger of the excitement and sudden-death nature of a survivor pool with the season-long grind of a fantasy game.

Additional features of the invention are described below in more detail.

### BRIEF DESCRIPTION OF THE DRAWINGS

The above-described and other advantages and features of the present disclosure will be appreciated and understood by those skilled in the art from the following detailed description and drawings of which

FIG. 1 is a preferred embodiment of a graphical user interface utilized in connection with the present invention highlighting the picking interface for selecting and/or swapping fantasy players on a user team;

FIG. 2 is a modified illustration of the graphical user interface for picking fantasy players of FIG. 1, highlighting the Quarterback position for selection by a user;

FIG. 3 is a modified illustration of the graphical user interface for picking fantasy players of FIG. 1, highlighting the Running Back position for selection by a user;

FIG. 4 is a modified illustration of the graphical user interface for picking fantasy players of FIG. 1, highlighting the Wide Receiver/Tight End position for selection by a user;

FIG. 5 is a graphical user interface as shown in FIG. 2, with statistical information of a player at the Quarterback position presented therein;

FIG. 6 is a modified illustration of the graphical user interface for picking fantasy players of FIG. 1, highlighting the Kicker position for selection by a user and displaying a rule restriction message;

FIG. 7 is a graphical user interface for picking fantasy players displaying a complete, 4-player fantasy team utilized in connection with the present invention after a user roster modification made in response to a rule restriction message;

FIG. 8 is a preferred embodiment of a graphical user interface utilized in connection with the present invention highlighting the dashboard interface which displays a selected fantasy team, a leaderboard, and game period rank prior to the start of real-world games to be played in a given game period;

FIG. 9 is a selected section from the dashboard interface of FIG. 8 displaying the rank of a team during a game period and points for the game period;

FIG. 10 is a preferred embodiment of a graphical user interface utilized in connection with the present invention highlighting the leader interface which displays the standings as well as statistical fantasy player contributions for the selected user listed in the standings;

FIG. 11 is a graphical user interface as shown in FIG. 10, with statistical performance information of a selected player presented therein;

FIG. 12 is a graphical user interface as shown in FIG. 10, with users eliminated in a prior game period;

FIG. 13 is a modified illustration of the dashboard interface of FIG. 8 displaying a selected fantasy team, a leaderboard, and game period rank and elimination tier after the start of real-word games played in a given game period; and

FIG. 14 is a flow diagram depicting a preferred embodiment of the method of user selection of players, elimination of elimination-tier users and a selection of a winner at the conclusion of the season or game span.

### DETAILED DESCRIPTION OF THE PRESENT INVENTION

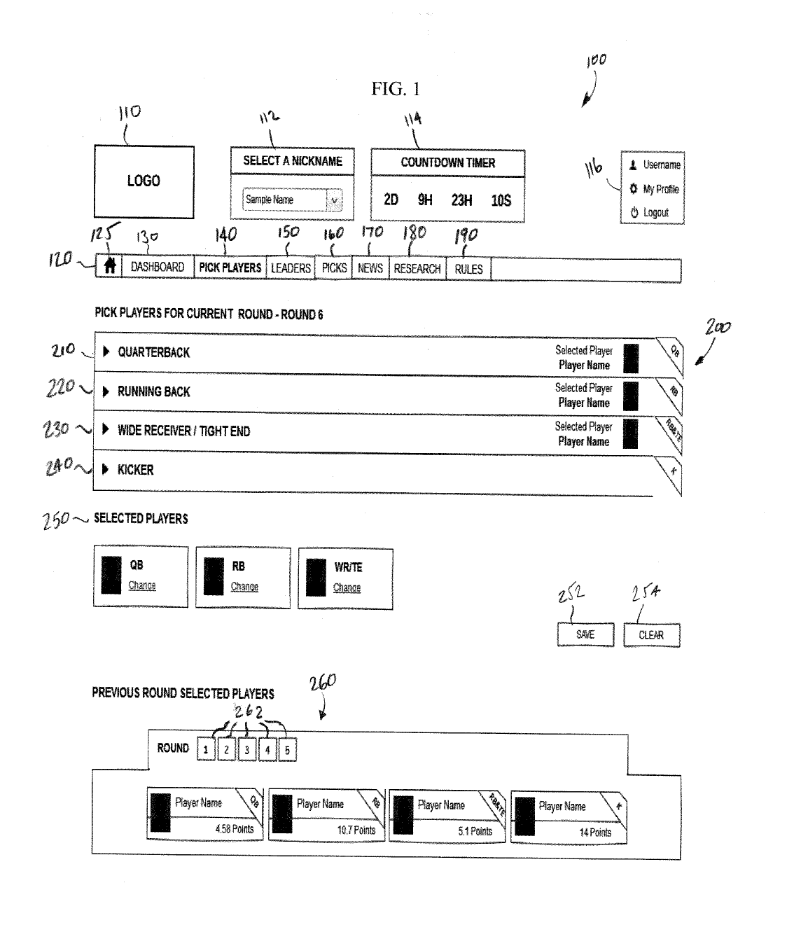

With reference to FIG. 1 through FIG. 13 there is shown various graphical user interfaces utilized in connection with the games and methods of the present invention. Generally, a user participates through the clicking, selecting and/or manipulating the graphical user interfaces displayed in the figures shown herein. For example, there are interfaces which enable a user to select players onto that user's roster, to view historical statistics and data of real-world athletes, to view a dashboard of real-time game updates and to view standings.

In a preferred embodiment of the present invention, each eligible user begins the game on equal footing. Each user is tasked with the selection of a fantasy player roster in a given sport. As demonstrated in FIGS. 1 through 13, when football is the sport, each user is tasked with the selection of four real-world players from the NFL, one of which is selected from each of four offensive categories, namely, Quarterback (QB), Running Back (RB), Wide Receiver/Tight End (WR/TE) and Kicker (K). After players are selected, points are awarded to the user's fantasy football team or account according to a points system assigned to various game events.

Below is a preferred scoring system utilized in connection with the game and method for the present invention as applied to football. Each of the players in a user's player roster or lineup for a given week or game sub-period earns points based on the players' actual statistics from their respective real-world games. The tables below list the statistics and their corresponding point values.

TABLE 4
For Quarterbacks, Running Backs, Wide Receivers and Tight Ends

| Points | Game Event |
|---|---|
| 6 | Rushing or Receiving TD |
| 6 | Returning Kick/Punt for TD |
| 6 | Returning or Recovering a Fumble for TD |
| 4 | Passing TD |
| 2 | Passing, Rushing or Receiving 2-Point Conversion |
| .1 | 1 Yard Rushing or Receiving |
| .04 | 1 Passing Yard |
| −2 | Interception thrown |
| −2 | Fumble lost |

An offensive player receives points for offensive statistics the selected athlete accumulates. Scoring is calculated utilizing the point system and game events set forth above. The following examples are illustrative of how points are calculated. Example 1: If a QB throws for 223 yards, 2 TDs and 1 Interception, and also rushes for 24 yards and 1 TD the point total for the week would be calculated as follows: 2 Passing TDs=8 points, 1 Interception=−2 points, 223 Passing Yards=8.92 points, 24 Rushing Yards=2.4 points, 1 Rushing TD=6 points. This totals 23.32 points for the week or game period. Example 2: If a WR catches 2 TDs, a pass for a 2-point conversion and compiles a total of 145 Receiving Yards, the point total for the week would be calculated as follows: 2 Receiving TDs=12 points, 1 2-point conversion=2 points, 145 Receiving Yards=14.5 points. This totals 28.5 points for the week or game period.

TABLE 5
For Kickers

| Points | Game Event |
|---|---|
| 5 | 50+ Yard FG |
| 4 | 40-49 Yard FG |
| 3 | 0-39 Yard FG |
| 1 | Extra Point |

For kickers, the points accumulated are limited to field goal and extra point production. Thus, a kicker receives points for offensive statistics the athlete accumulates according to the game events set forth above. For more difficult field goals of 40 or more yards, bonus points are awarded. A single point is awarded to a kicker for each extra point made by the kicker.

Of course, it should be appreciated and understood that the scoring system, game events and number of players selected at each position, as described above, may be modified and customized as desired to appeal to more users. Thus, for example, for users who wish to play with defensive categories, additional game events may be provided that award or deduct points based on defensive game events and statistics. Likewise, defensive teams or individual defensive players may be selected as additional positions to be selected. Moreover, additional players may be selected at the RB or WR/TE position each week to make for a larger user roster for each game period. A game with fewer than four players may likewise be created for a given roster.

In a preferred embodiment, once a real-world player is selected for game period by a user, that player may not be selected again by that user for a restricted period of time. In most preferred embodiments, the restricted period of time equals the entire game span, such that once a player is selected once, that player may no longer be selected for the remainder of the season.

With reference to FIG. 1, there is shown a graphical user interface 100 utilized in connection with the present invention. At the top of this and many other interfaces presented in the figures, there is a logo field 110 for logos, such as the name of the game (e.g. VYVOR™), or other logos that may be selected or created and uploaded by a user. Alternatively, the logo field 110 may comprise a photograph selected by a user or a stock illustration provided for selection to a user as the user's logo. Adjacent to the logo field 110 is a nickname field 112 for nicknames that can be selected or created by a user. Typically a nickname refers to the user's team name by which the system or other users can refer to a particular user and the user's team.

Adjacent to the nickname field 112 is a countdown timer 114 which counts down the time to the start of games for a game period. For example, with the current scheduling of games in the NFL, since a given game period or week's games typically begin with one or two football games that are played on Thursday evening (EST) and typically end late on the following Monday evening (EST), the timer is preferably set to begin its countdown starting on Tuesday at 12 A.M. (EST) (or just after the final Monday night game concludes, if it extends past midnight). The countdown timer thus notifies users of the start of next week's or next game period's games which effectively may serve as a deadline by when user teams must be selected. Alternatively, rules of a given league can be modified to allow for the countdown timer to be extended, for example, to the start of Sunday afternoon games when most games in a given week are played. If the timer is extended to allow for players to be selected up until Sunday's games (which occur after the first game of the week period has already been played), it should be appreciated that players who have already played cannot be selected onto a user's fantasy roster. In that regard, once a player has begun to play a game, that player may no longer be selected onto a user's active roster for the week.

Adjacent to the countdown timer 114 is a profile menu 116 which contains options that permit a user to select and/or change the user's username, basic information in a user's profile (e.g., name, address, email address, age, payment means, etc.) and to logout of the system. It should be appreciated that all user subscribers gain entry and access by (paid or unpaid) subscription and by using known security approaches, such as a login and password, which are optionally managed by a separate login server or software. Once a login is confirmed and a user authenticates, the verified user is permitted access to the functions and interfaces of the system.

A menu 120 is provided for display on interface 100 and comprises a number of user-selectable buttons that link or point to user interfaces and system components utilized in connection with the games and methods of the present invention. In preferred embodiment, menu 120 comprises the following selections: Dashboard 130, Pick Player 140, Leaders 150, Picks 160, News 170, Research 180 and Rules 190. A home page 125 is also provided to bring users back to the home page.

As shown in FIG. 1, when the Pick Players 140 button is selected, interface 100 is presented via which a user may select players from positions 200 for a particular fantasy game. In the case of football, those positions made available in the preferred embodiment are Quarterback or QB 210, Running Back or RB 220, Wide Receiver/Tight End or WR/TE 230 and Kicker or K 240. After players are successfully selected, a graphic and/or visual indicia of those players (e.g., photos, names, jersey numbers, position) are displayed in the selected players area 250 of the interface 100. In the interface 100 shown in FIG. 1, the successfully selected players area 250 of interface 100 include the QB Position 210, RB Position 220 and WR/TE Position 230, but no players have been yet successfully selected in the K Position 240, which is still available for selection by a user. A Save option 252 and Clear option 254 are provided to permit a user to save his position player selections or to clear them from selection, respectively. If the Clear option 254 is selected after a team has been picked, a user must successfully re-select players to fill the respective positions 210, 220, 230, 240. Accordingly, just like players are initially selected in their respective positions, 210, 220, 230, 240, those players may be swapped for other players after being successfully selected.

When Pick Players 140 is selected, interface 100 also has a Previous Round Selected Players display 260 (at the bottom) of the players selected in prior game periods. Since interface 100 pertains to the selection of players for Round 6 or the sixth game period, the Previous Round Selected Players display 260 is adapted to display players selected in any of the previous five rounds or game periods, along with the players respective fantasy point totals during that particular game period. To select a particular game period, a user selects one of the game period buttons 262. Selection of the number 1 will display the players selected in game period 1, selection of the number 2 will display the players selected in game period 2 and so on and so forth. As a user participates in additional game periods and avoids elimination, the Previous Round Selected Players display 260 generates more game period buttons to accommodate those additional prior rounds or game periods in which a user participated.

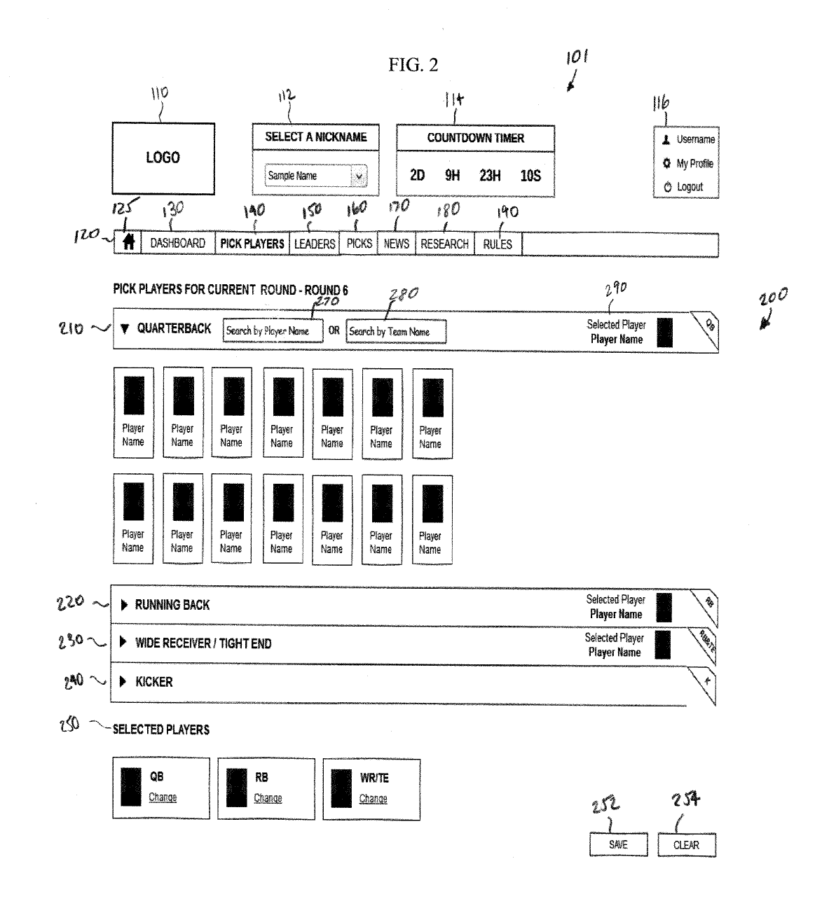

With reference to FIG. 2, interface 101 is presented which is a slightly modified version of interface 100. In interface 101, Quarterback position 210 is highlighted for selection by a user. In making the selection, a player search window 270 and a team search window 280 is provided to assist in the search to fill the Quarterback position 210. Preferably, the players are listed alphabetically and most have available photographs for identification. If a player to fill Quarterback position 210 is already selected, a graphic or visual indicia 290 corresponding to that player will be present. The player will also be shown in the selected players area 250.

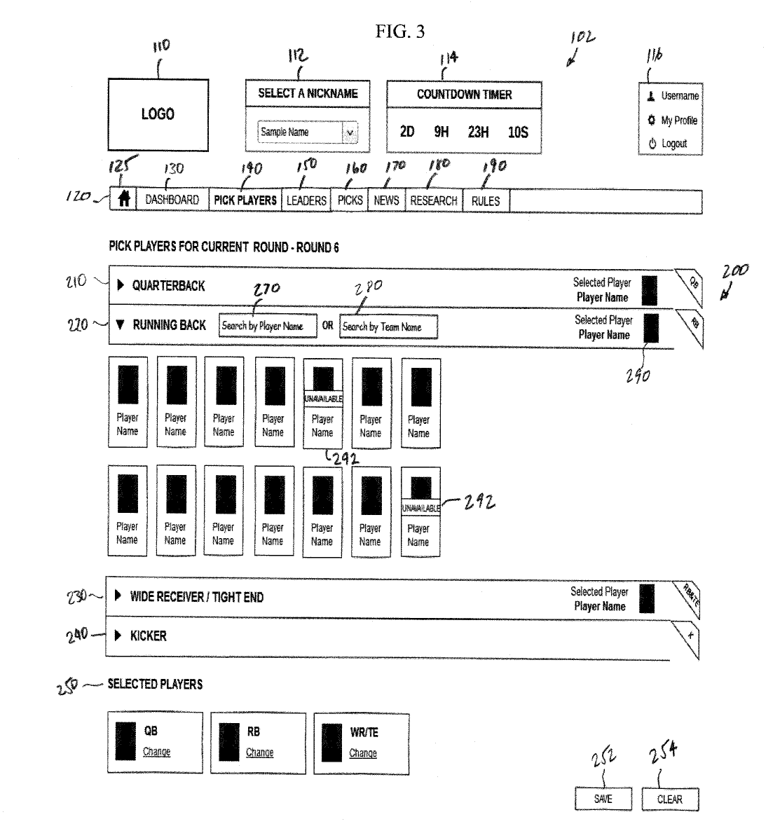

With reference to FIG. 3, interface 102 is presented which is a slightly modified version of interface 100. In interface 102, Running Back position 220 is highlighted and expanded for selection by a user. In making the selection, a player search window 270 and a team search window 280 is provided to assist in the search to fill the Running Back position 220. Preferably, the players are listed alphabetically and most have available photographs for identification. If a player to fill Running Back position 220 is already selected, a graphic or visual indicia 290 corresponding to that player will be present. The player will also be shown in the selected players area 250. Notably two players are presented with an ‘UNAVAILABLE’ label across the graphic 292. These Running Back position 220 players were selected in prior game periods and are thus now presented as being an unavailable player 292.

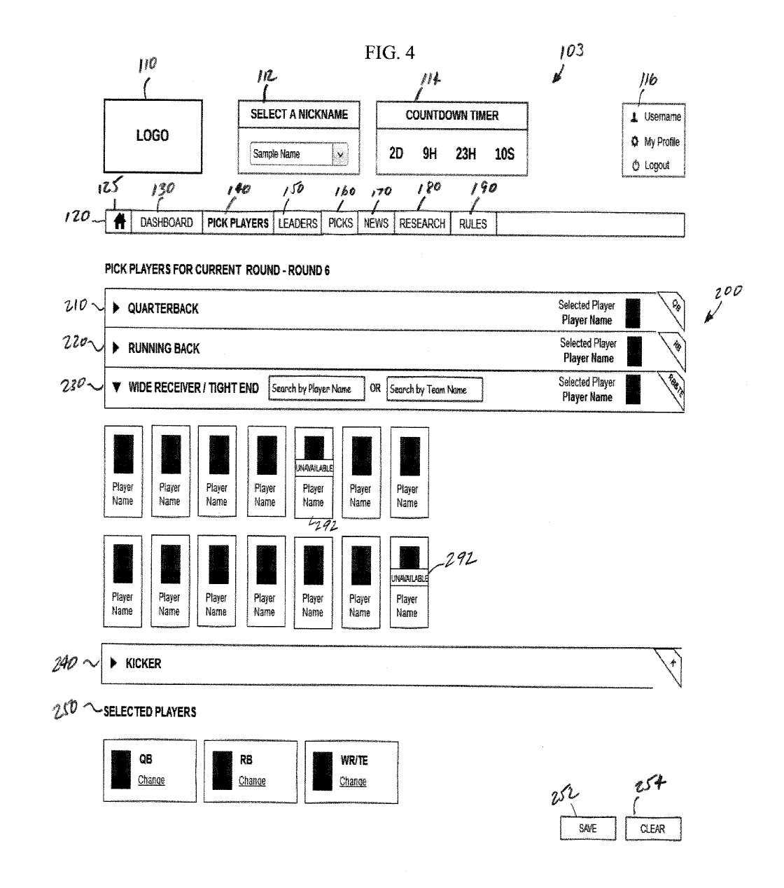

With reference to FIG. 4, interface 103 is presented which is a slightly modified version of interface 100. In interface 103, Wide Receiver/Tight End position 230 is highlighted and expanded for selection by a user. In making the selection, a player search window 270 and a team search window 280 is provided to assist in the search to fill the Wide Receiver/Tight End position 230. Preferably, the players are listed alphabetically and most have available photographs for identification. If a player to fill Wide Receiver/Tight End position 230 is already selected, a graphic or visual indicia 290 corresponding to that player will be present. The player will also be shown in the selected players area 250. Notably two players are presented with an ‘UNAVAILABLE’ label across the graphic 292. These Wide Receiver/Tight End position 230 players were selected in prior game periods and are thus now presented as being an unavailable player 292.

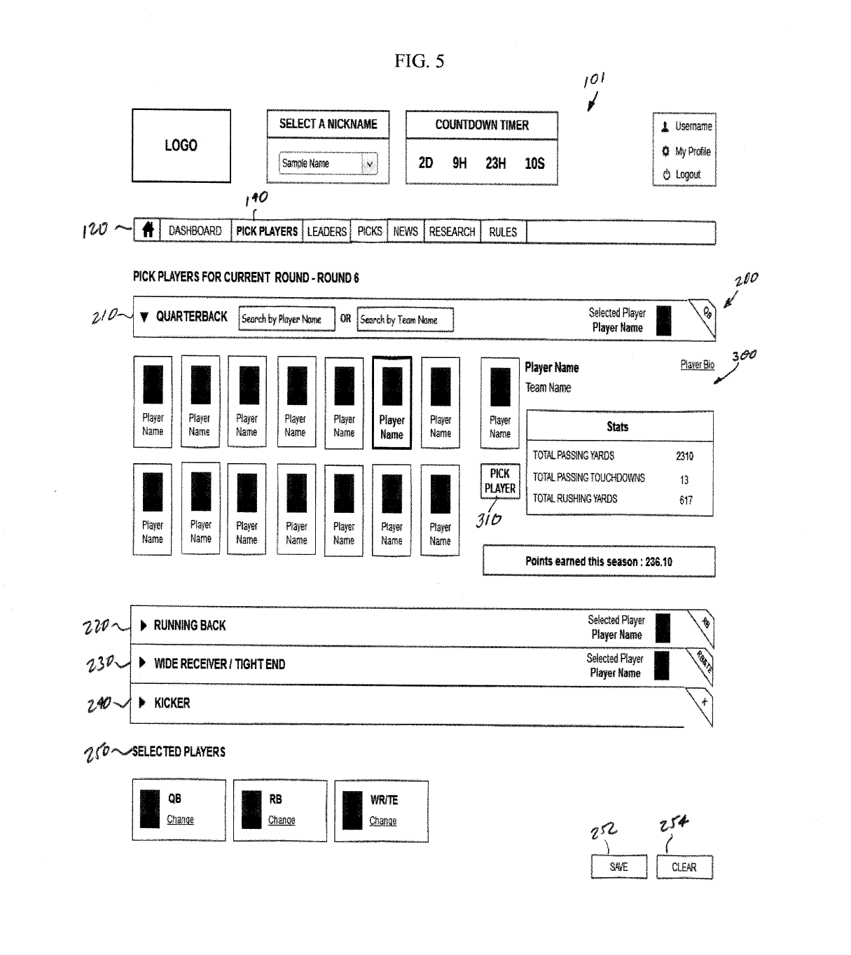

With reference to FIG. 5, the user interface 101 of FIG. 2 further displays a window 300 having statistical information corresponding to a player that is highlighted for selection from the available list of Quarterbacks. In this instance the highlighted player is in a pre-selected status and is shown to have statistics of 2310 passing yards, 13 passing touchdowns and 617 rushing yards with a total to-date point total of 236.10 points. After a player image or representation is highlighted, the interface enables a user to select or pick the player for promotion to the user's team roster for that week or game period. In particular, to successfully select the player to fill the Quarterback position 210, a user must activate the Pick Player button 310. It should be appreciated that for other candidates available for selection, the interface 101 and window 300 displays that player's relevant statistical information, in this case, the QB's total passing yards, total passing touchdowns and total rushing yards.

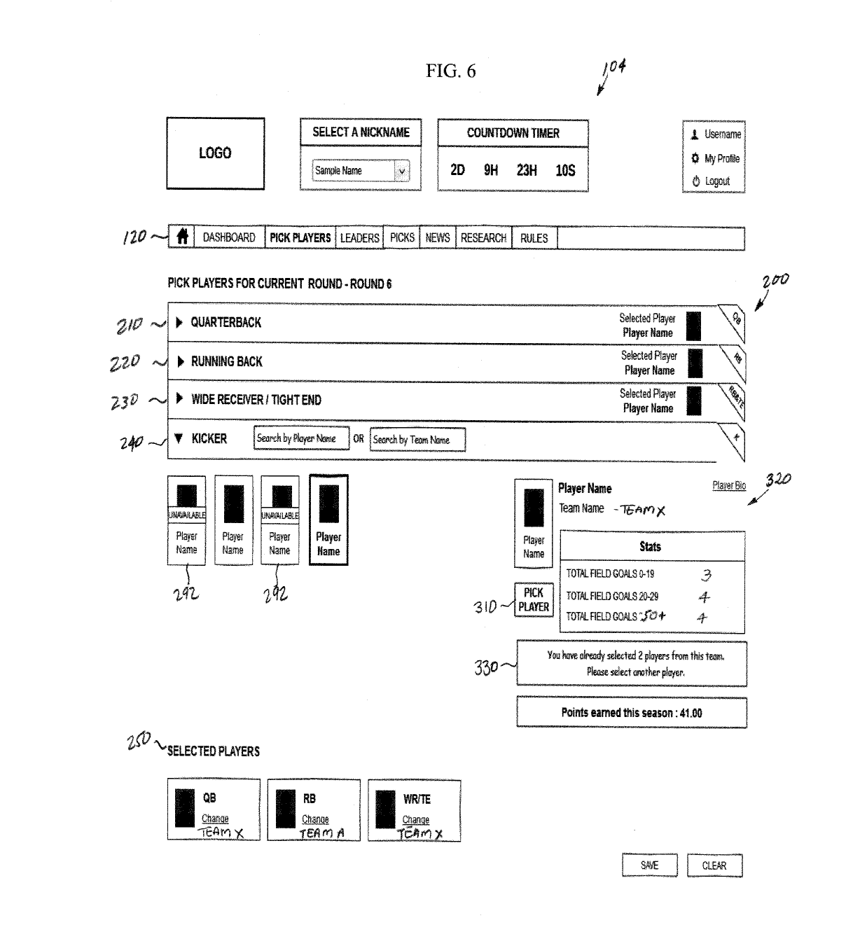

With reference to FIG. 6, interface 104 is presented which is a slightly modified version of interface 100. In interface 104, Kicker position 240 is highlighted and expanded for selection by a user. In making the selection, a player search window 270 and a team search window 280 is provided to assist in the search to fill the Kicker 240. Preferably, the players are listed alphabetically and most have available photographs for identification. In this instance, since there was no player already selected to fill the Kicker position 240, there is no graphic or visual indicia corresponding to that player present in the selected players area 250. Notably two Kickers are presented with an ‘UNAVAILABLE’ label across the graphic 292. These Kickers were selected in prior game periods and are thus now presented as being an unavailable player 292.

FIG. 6 further displays a window 320 having statistical information corresponding to a player that is highlighted for selection from the available list of Kickers. In this instance the highlighted player is in a pre-selected status and is shown to have statistics of 3 field goals between 0-19 yards, 4 field goals between 20-29 yards and 4 field goals of 50 or more yards with a total to-date point total of 41 points. After a player image or representation is highlighted, the interface enables a user to successfully pick the player for promotion to the user's team roster for that week or game period. In particular, to select the player to fill the Kicker position 240, a user must activate the Pick Player button 310. It should be appreciated that for other candidates available for selection, the interface 104 and window 320 displays that player's relevant statistical information, in this case, the K's total field goals in each range hit (and extra points).

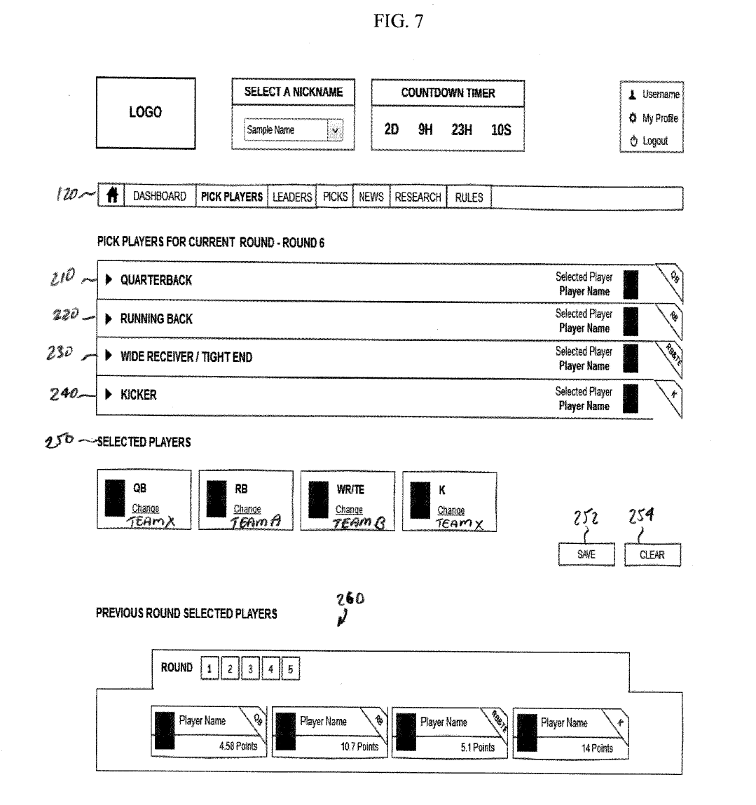

FIG. 6 further presents an alternative embodiment of the game and methods disclosed herein which also limits the number of players that may be selected from a given professional sports team in a given game period to two players. Here, since two of the three previously selected positions (i.e., QB, RB, WR/TE) comprise players from the same professional sports team (i.e., Team X), the user receives an error message 330. The kicker that the user is attempting to select for the Kicker position 240 may not be promoted to the user roster for the game period since that user is also on Team X. As shown in FIG. 7, the user may amend the selection for Wide Receiver/Tight End position 230 and successfully pick another player to that position 230 from Team B, thus allowing the user to select the kicker from Team X that user intended to promote to the Kicker position 240 in the game period.

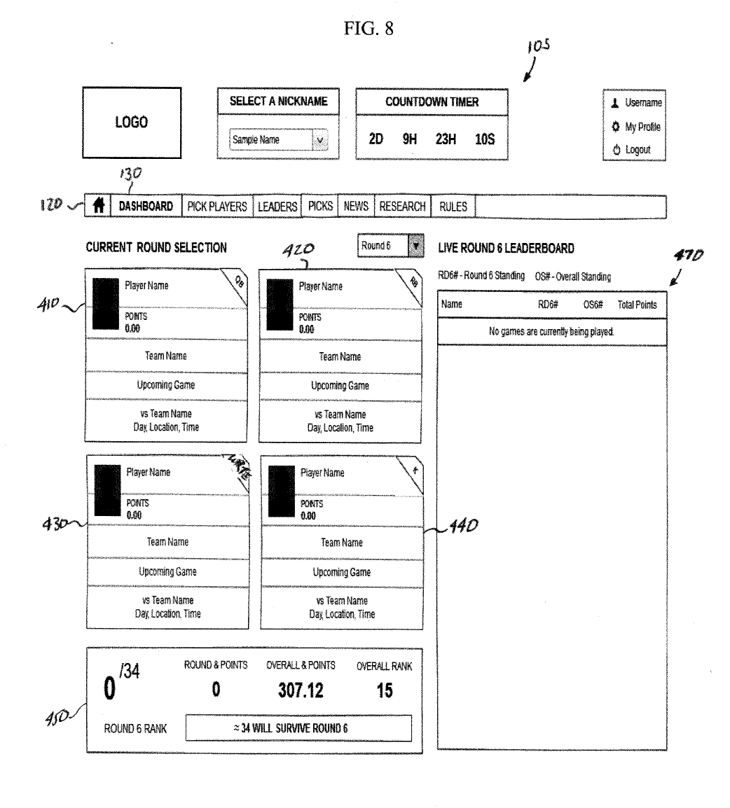

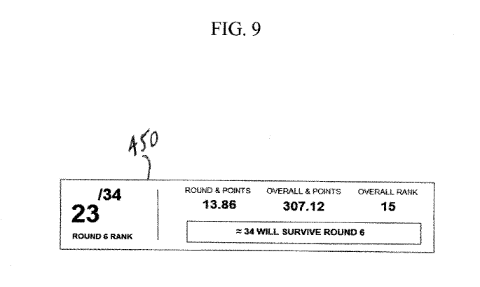

With reference to FIG. 8 and FIG. 9, after a user successfully selects and saves the players for the week, the players appear by position in QB, RB, WR/TE and K windows 410, 420, 430, 440 on a dashboard interface 105. The bottom of the dashboard interface 105 displays a scoring bar 450 which displays the user's points for the gamer period or week, the overall points from accumulated points from the start of the season or game span, the user's weekly or game period rank as well as an overall rank based on users that remain from the start of the game span or season. There is also a ‘live’ leaderboard 470 on the dashboard 105 during live NFL games as they are played. Before games begin, the leaderboard appears inactive.

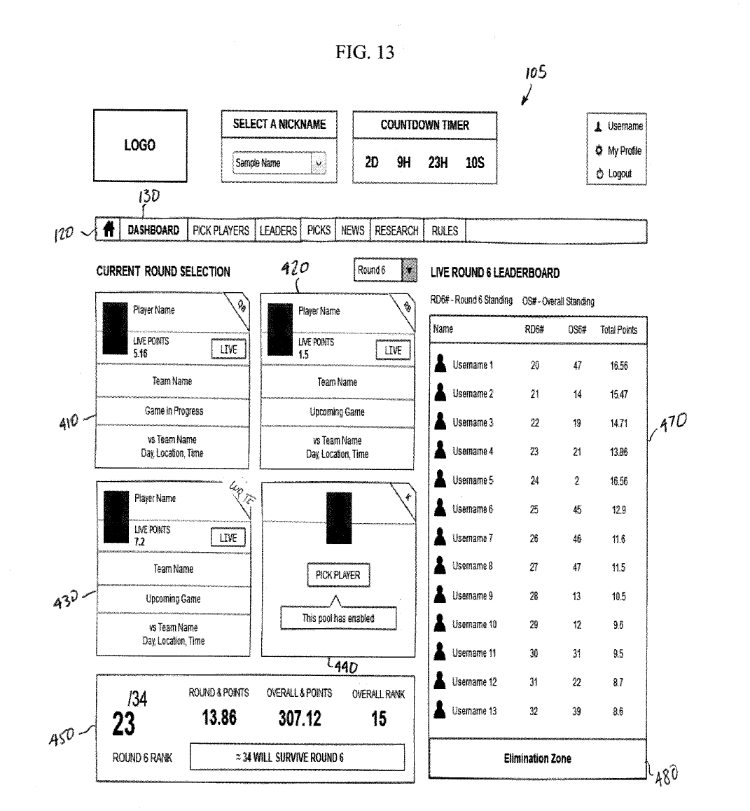

FIG. 13 illustrates the dashboard interface 105 of FIG. 8 but displays the live leaderboard 470 which is actively in flux once the live NFL games commence for the week or game period. On the left, the individual players have their live points displayed below their name at each position 410, 420, 430, 440. On the right, the leaderboard 470 displays both the user's weekly standing as well as the user's overall standing. This is updated in real time as the fantasy points are loaded into the system. The live leaderboard 470 further comprises a live “Elimination Zone” which indicates the cutoff line for participants to survive that particular week. If the players fall into this zone at the end of play for the week, the user is eliminated from the game, regardless of the total number of points accumulated for the season.

Depending on the rules of a given league, and in the preferred embodiment, each user earns weekly points as well as points towards each user's season total. Each week a user begins with zero weekly points. After each week (or game period), participants who finish in the bottom designated percentage of all active users or league members are placed in the lowest or elimination tier and are eliminated from contention. For example, in a preferred embodiment, after Week 1 of the NFL regular season, the bottom 6% of user teams are eliminated from contention at the end of Round 1. Preferably, this percentage rises each week according to the schedule in Table 6 below. This practice continues until the end of the season or until there are less than 100 survivors. At the end of the season, the surviving player with the most ‘Season to Date’ points is awarded the Grand Prize. In addition, weekly prizes are available to the top finisher(s) based on the most total points accumulated during a given week. It should be appreciated that the preferred elimination formula referenced herein may be modified, such as to eliminate more or less players each week, while still keeping within the spirit and scope of the present invention.

At the conclusion of each week, users who fall in the bottom percentage of participants are eliminated, and in a preferred embodiment, those users are no longer eligible to participate in the prize pool or game. However, any weekly prizes previously won are still valid. If multiple users with the same weekly total fall on the “cut line,” they all advance to the following week even though that means the percentage of the survivors is more than that stated below. Optionally, a tie-breaker may be instituted to decide which user on a cut line is eliminated and which one moves on. The percentage of surviving users eliminated each week is presented in the following chart.

TABLE 6

| Game Period | Percent Eliminated from Contention |
|---|---|
| Week 1 | 6.00% Eliminated |
| Week 2 | 6.38% Eliminated Of Existing Survivors |
| Week 3 | 6.81% Eliminated Of Existing Survivors |
| Week 4 | 7.31% Eliminated Of Existing Survivors |
| Week 5 | 7.89% Eliminated Of Existing Survivors |
| Week 6 | 8.57% Eliminated Of Existing Survivors |
| Week 7 | 9.37% Eliminated Of Existing Survivors |
| Week 8 | 10.34% Eliminated Of Existing Survivors |
| Week 9 | 11.53% Eliminated Of Existing Survivors |
| Week 10 | 13.04% Eliminated Of Existing Survivors |
| Week 11 | 15.78% Eliminated Of Existing Survivors |
| Week 12 | 20.00% Eliminated Of Existing Survivors |
| Week 13 | 25.00% Eliminated Of Existing Survivors |
| Week 14 | 33.33% Eliminated Of Existing Survivors |
| Week 15 | 50.00% Eliminated Of Existing Survivors |
| Week 16 | Top 100 Survive |
| Week 17 | Grand Prize For User With Highest Season |
| | Total Points |

While the eliminated users are designated herein as a percentage, it should be appreciated that a fixed number of users may be designated each week as an alternative until a desired number of users remain for the final game period or game. Utilizing the percentage method allows the game to be scaled to any size, unlike the traditional fantasy games that are often limited in size by design. This enables larger contests and prizes which are typically only found in survivor pools.

It should be understood and appreciated that the information, scoring and elimination percentages contained in Table 4, Table 5 and Table 6 hereof may be presented to users under the Rules tab 190 of menu 120. Likewise, other rules and limitations referenced herein, may be presented under the Rules tab 190 as well. For rules that are optional or may be modified, an input interface (not shown) may be provided to customize the point system, elimination percentages and prizes awarded in a custom league.

Another preferred embodiment of the present invention enables additional games to be implemented and commenced at any point during the NFL season that are entirely separate from the week one NFL pool. While the overall rules are preferably the same, the percentage or number of players eliminated each week will be subject to change. There may also be multiple pools run at the same time with different entry fees to attract a wider audience. All participants may join these new pools whether or not they survived the previous contests or were prior participants.

Other rules incorporated into the preferred embodiment of the present invention are presented herein. With respect to deadlines, if a user fails to make one or more selections in a given game period or week, that user continues in the pool for that week. However, since the user only earns points for selections that are actually successfully made, that user will earn zero points for game period and will likely be eliminated. In the preferred embodiment, default selections for users are not made.

With respect to the selection of players who are playing in a game that is about to commence, a participant may unselect the players already on a fantasy team, or select players to a position on the user's fantasy team, up to until about five minutes prior to the scheduled game time. In the most preferred embodiment, players may be selected and deselected until a real-world game actually begins. However, in an effort to avoid scoring errors or programming conflicts, it is preferable to provide a buffer of at least a minute.

Following the completion of each week's games, all statistics and point totals are verified and corrections are made where necessary. However, because users are eliminated with each week that passes, all statistics and point totals for the week are considered final as of 11:59:59 P.M. EST on Wednesday, the day before the earliest game of the following week. If a stat correction is announced for the previous week's or game period's games after this time frame, it is generally not included and the official fantasy score of users potentially affected by the statistics change is based exclusively on the original statistic.

Grand prizes are generally awarded based on total accumulated points (or where users finish in the final game of a game span). In the event of a tie, the following tie-breakers apply: if more than one player finishes with the same overall points for the season, the tie-breaker is the total points earned in the final game period. If there is still a tie, the winner is determined by the total points earned in the second to last game period. In the event that the ties continue until the first game period, the survivors split the grand prize evenly.

Weekly prizes are awarded based on users with the highest point totals in each game period, irrespective of whether those same users were eliminated in subsequent game periods. In the event of a tie in a given week, the following tie-breakers apply in the following order (1) total points earned by the Quarterback position in that week; (2) total points earned by the Running Back position in that week; (3) total points earned by the Wide Receiver/Tight End position in that week; (4) total points earned by the Kicker position in that week; (5) total points earned the previous week; (6) earliest time-stamp among participants when final selections were locked in for the week; (7) in the event that none of the above breaks the tie, the winner is selected via a random number generator.

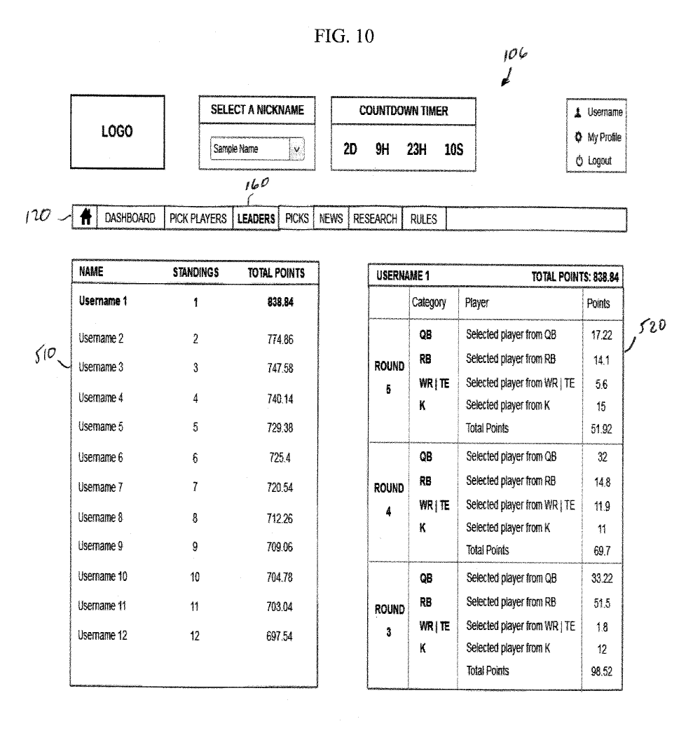

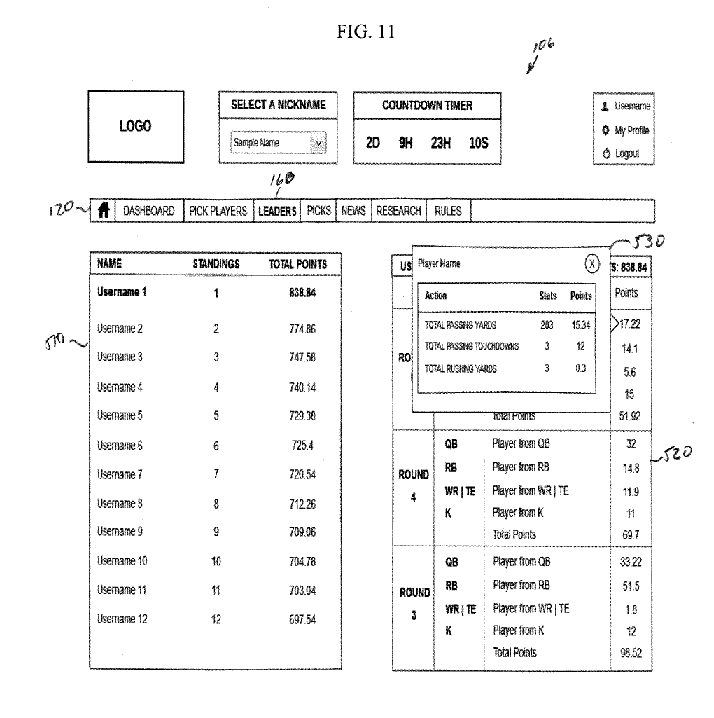

With reference to FIG. 10, when clicking on the Leaders tab 160 interface 106 is presented, displaying and listing all of the users remaining in the game by their overall standing and total cumulative points in window 510. A user can click on or select any of the participant user names and each of their weekly selections are displayed on the right window 520 along with the total points scored for each player selected at a given position (QB, RB, WR/TE and K), and the total points earned by the user's fantasy team for the week or game period. This feature permits users to conduct research on each other's teams and in some instances, formulate a selection strategy to overcome other players, depending on which players are or are not available to specific users going forward in the coming game periods. As shown in FIG. 11, a user can also view how a selected player amassed the fantasy points earned in a prior week or game period. The user clicks on or selects points total and a pop-up box 530 appears on the interface 106 displaying the breakdown of the fantasy points.

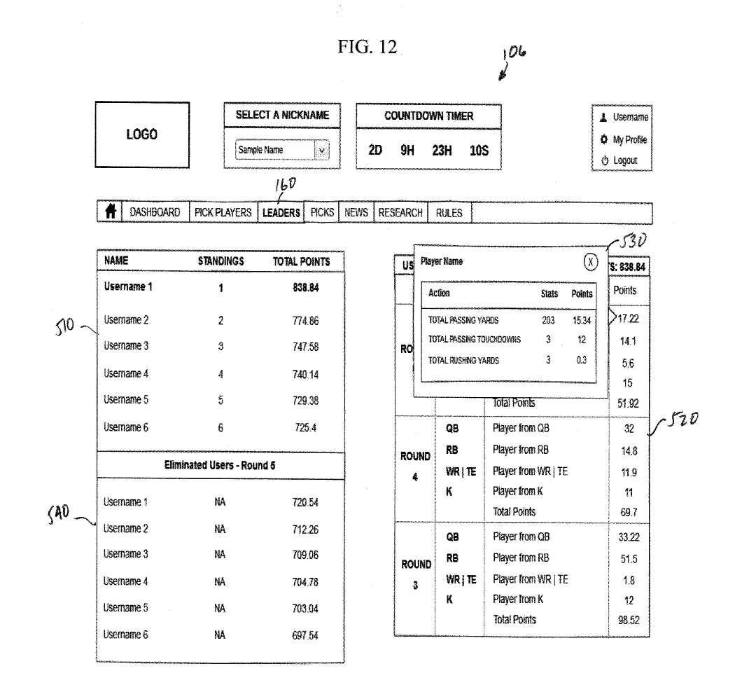

With reference to FIG. 12, interface 106 provides a list of eliminated users 540 as an addendum to the leaders tab 160. While some of the eliminated users have more accumulated points than those users still participating, each of the eliminated users endured one week where their respective performances were below the predetermined cutoff percentage for the week and they were thus eliminated. In that regard, it is often advantageous for users to pick players who play consistently, even if those players are not as ‘explosive’ and have a perceived ceiling as to the points that those players can score in a given week.

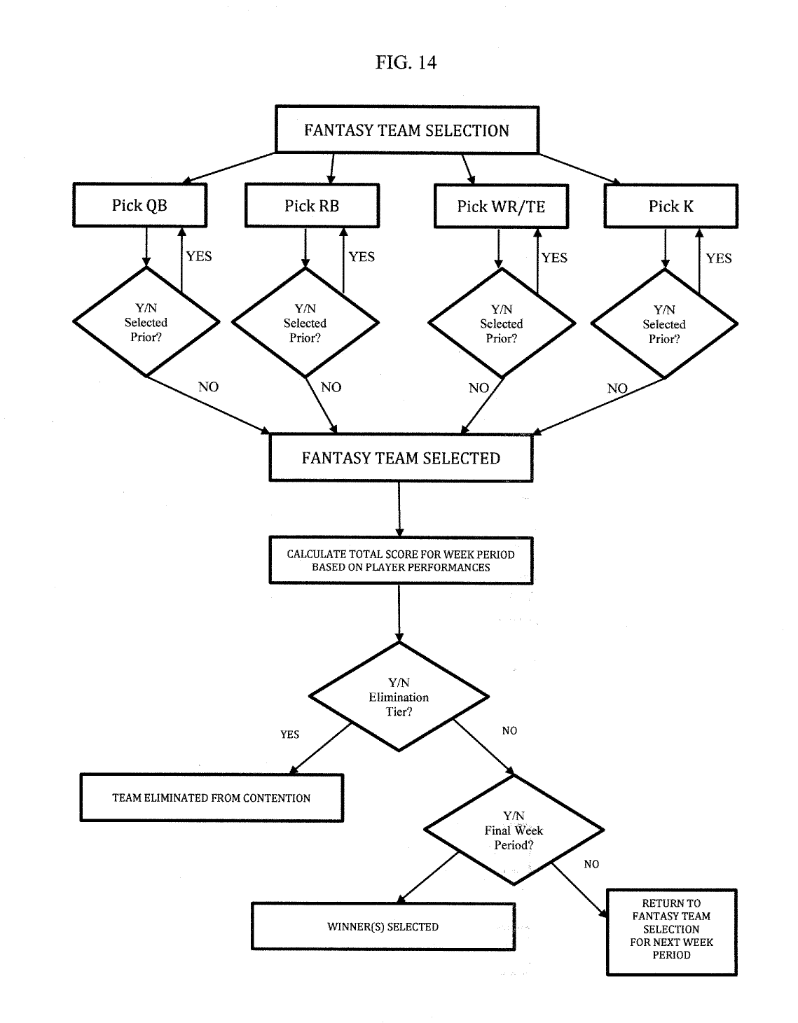

FIG. 14 illustrates a flow diagram depicting the overall process by which a user selects players, users are eliminated and a winning user is selected at the conclusion of the season or game span. After login, and prior to the commencement of a game span, a user selects players for a fantasy team. As each player is selected by a user, the system checks and determines whether that player was selected in a prior game period. If the answer is ‘No,’ then that player is successfully selected and promoted to a user's active roster for a given game period. If the answer is ‘Yes,’ then an error message appears and that player may not be selected for promotion or placement on a user's active roster for the game period. Obviously, for the first game period, all roster selections will successfully pass this validation check. After a fantasy roster or team is successfully selected, the players on each fantasy team accumulate points. Points are calculated and tallied pursuant to the rules and point systems set forth, for example, in Table 4 and Table 5 and each team earns a total fantasy score. As scores are tallied and totaled, a check is performed to determine whether a given user is in the lowest tier or ‘elimination tier’. If the answer is ‘Yes,’ then that player is eliminated from contention. If the answer is ‘No,’ then a further check is performed to determine whether it is the last game period of the game span. If the answer is ‘No’ then the user survives and is placed into the pool for selection of another team for the next game period. However, if the answer is ‘Yes,’ then a user is declared the winner and awarded the grand prize. Obviously, for leagues that award multiple prizes to users who do not finish in first place, additional checks and tiers may be implemented and incorporated.

It should be appreciated that the games and methods of the present invention is scalable to any large number of users. Certainly, by implementing elimination percentages at the end of each game period, the number of users remaining towards the end of a given season can be tailored and placed under control.

It should further be understood that a preferred embodiment of the present invention restricts players to a single use during a given game span. Thus, for example, once a player is selected and locked into a user roster for a given week, that player is no longer eligible to be placed on the same user's roster during future weeks of the season. Locking into a user roster generally occurs when the weekly deadline has been reached. The deadline is either once the player's game commences or at the published weekly deadline, whichever is earlier. However, it should be appreciated that a player may be locked into a user roster upon selection of that player to the roster for a given week's game. While the foregoing represents a preferred embodiment, an alternate embodiment may implemented to enable a given player to be used more than once (e.g., up to 4 times per season) but cannot be used, for example, in consecutive weeks.

Likewise, while all four players on a user roster may conceivably be chosen from a single NFL team, restrictions may be placed on each user roster which limit the number of players on a particular NFL team (e.g., one or two players), as noted in a prior example above.

Moreover, while a preferred embodiment disclosed herein is written in the context of the game of football, utilizing players selected from the NFL and a point system based on NFL scoring and performance statistics, it should be appreciated that the game and method disclosed herein may easily be modified to incorporate other real-world games, such as baseball, basketball, hockey, soccer and other sports played around the world.

With respect to hockey, statistics, such as goals scored, assists and goals scored against may be utilized to tally fantasy points. Positions may include forwards, defensemen and goalies.

With respect to basketball, statistics, such as points scored, assists, rebounds, steals, blocked shots, free throws made, free throw percentage, three pointers made, three point percentage may be utilized to tally fantasy points. Positions may include guards (point guards, shooting guards), forwards (small forwards, power forwards) and centers.

With respect to baseball, statistics such as hits, doubles, triples, RBIs, HRs, stolen bases, batting average, innings pitched, strikeouts, WHIP, ERA, wins, losses, saves and blown saves may be utilized to tally fantasy points. Positions may include players at the following positions 1B, 2B, 3B, SS, C, LF, CF, RF, OF, SP, RP, P.

The accompanying description and figures only illustrate a small number of the embodiments of the game, methods and interfaces of the present invention. However, other forms and embodiments are possible. Accordingly, the description and figures are not intended to be limiting in that regard. Thus although the description above and accompanying figures contain much specificity, the details provided should not be construed as limiting the scope of the embodiments but merely as providing illustrations of some of the presently preferred embodiments. The figures and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments may be practiced by those of ordinary skill in the art without departing from the spirit and scope of the invention.

1. With a processor-controlled system in communication over a computer network with a non-transitory computer readable storage medium, a method of playing a fantasy survivor game with a plurality of users over the course of a game span having a plurality of game periods, comprising the steps of:
displaying for said plurality of users a plurality of players at designated positions eligible to be selected for users' fantasy game teams;
determining whether each of said players selected by a user has previously been selected to that user's fantasy game team in a prior game period;
allowing said players to be selected to said user's fantasy game team if said determining step is negative;
calculating a total number of fantasy points earned by said plurality of players for each of said users' fantasy game teams;
eliminating all users' fantasy game teams from contention when said users' fantasy game teams do not score sufficient points to remain above an elimination tier in a pool of users; and
repeating said displaying, determining, allowing, calculating and eliminating steps until a single winner is determined.

2. The method of claim 1, wherein said designated positions comprise Quarterback, Running Back, Wide Receiver and Kicker.

3. The method of claim 1, wherein said single winner is determined at the conclusion of the final game period and said single winner is user with the highest total of fantasy points combined from all of the game periods of said game span.

4. The method of claim 1, further comprising the step of precluding said players to be selected to said user's fantasy game team if said determining step is positive.

5. The method of claim 1, wherein said calculating step is performed in real time for players as they are playing in a game.

6. The method of claim 5, wherein said players are players in the NFL.

7. The method of claim 6, wherein said game period is a week of the NFL regular season.

8. The method of claim 6, wherein said game period is a week of the NFL playoffs.

9. The method of claim 7, wherein said game span comprises 13-17 weeks of the NFL regular season.

10. The method of claim 1, wherein said winner is determined in the last game period of said game span.

11. The method of claim 10, wherein said winner is the user having a fantasy game team with the most accumulated points for the game span.

12. The method of claim 10, wherein said winner is the user having a fantasy game team with the most points during the last game period of said game span.

13. A non-transitory computer readable storage medium, in communication over a network with other CPU-controlled devices, said non-transitory computer readable storage medium storing one or more programs, the one or more programs comprising instructions which control the play of a fantasy survivor game with a plurality of users over the course of a game span having a plurality of game periods and which when executed by a computer, cause the computer to:
display for said plurality of users a plurality of players at designated positions eligible to be selected for users' fantasy game teams;
determine whether each of said players selected by a user has previously been selected to that user's fantasy game team in a prior game period;
allow said players to be selected to said user's fantasy game team if said determining step is negative;
calculate a total number of fantasy points earned by said plurality of players for each of said users' fantasy game teams;
eliminate all users' fantasy game teams from contention when said users' fantasy game teams do not score sufficient points to remain above an elimination tier in a pool of users; and
repeat said displaying, determining, allowing, calculating and eliminating steps until a single winner is determined.

14. The device of claim 13, wherein said designated positions comprise Quarterback, Running Back, Wide Receiver and Kicker.

15. The device of claim 13, wherein said single winner is determined at the conclusion of the final game period and said single winner is user with the highest total of fantasy points combined from all of the game periods of said game span.

16. The method of claim 13, wherein said calculating step is performed in real time for players as they are playing in a game.

17. The method of claim 16, wherein said game period is a week of the NFL regular season.

18. The method of claim 17, wherein said game span comprises 13-17 weeks of the NFL regular season.

19. The method of claim 18, wherein said winner is determined in the last game period of said game span.

20. With a processor-controlled system in communication over a computer network with a non-transitory computer readable storage medium, a method of playing a fantasy survivor game with a plurality of users over the course of a game span having a plurality of game periods, comprising the steps of:
selecting a plurality of players for a plurality of designated positions, said players being available for a user's fantasy game team;
selecting alternate players for one or more of said plurality of designated positions, when said players are prohibited from promotion to said user's fantasy game team; team;
receiving on a display interface a calculated total number of fantasy points earned by said plurality of players for said user's fantasy game team in one of said plurality of game periods;
receiving on a display interface an indication as to whether said user's fantasy game is in an elimination tier;
repeating said selecting a plurality of players, said selecting alternate players, and said receiving steps until a single winner is determined.
